(19) United States
(12) Patent Application Publication
(10) Pub. No.: US 2024/0187453 A1
(43) Pub. Date: Jun. 6, 2024

(54) NETWORK SECURITY FOR MULTIPLE FUNCTIONAL DOMAINS

(71) Applicant: Salesforce.com, Inc., San Francisco, CA (US)

(72) Inventor: Chaitanya Pemmaraju, San Francisco, CA (US)

(73) Assignee: Salesforce.com, Inc., San Francisco, CA (US)

(21) Appl. No.: 18/075,263

(22) Filed: Dec. 5, 2022

(51) Int. Cl. H04L 9/40

(52) U.S. Cl. CPC H04L 63/166; H04L 63/0236; H04L 63/029; H04L 63/20

(57) ABSTRACT

Methods, systems, and storage media are described for providing network security across multiple functional domains. In particular, some implementations are directed to encapsulating data packets sent from one functional domain to another with fully qualified security group (FQSG) information to allow the destination domain to process the data packet based on the FQSG information from the source domain. Other implementations may be disclosed or claimed.

### TECHNICAL FIELD

Some implementations disclosed herein are directed to network security across multiple functional domains. In particular, some implementations are directed to encapsulating data packets sent from one functional domain to another with fully qualified security group (FQSG) information to allow the destination domain to process the data packet based on the FQSG information from the source domain.

### BACKGROUND

The advent of powerful servers, large-scale data storage and other information infrastructure has spurred the development of advanced data warehousing applications. For example, cloud computing uses a network of remote servers hosted on the Internet to store, manage, and process data, rather than a local server or a personal computer. To leverage the global infrastructure provided by cloud service providers (CSPs) and to expand software services into other geographies, entities such as business or enterprises are continuing to move software services from in-house systems to the public cloud.

Some systems may include different functional domains (e.g., within a common functional instance or in different functional instances). Conventional security group processing may suffice within a single functional domain (FD), but once a data packet leaves a FD boundary using public proxy and undergoes network address translation (NAT) to go out on the Internet to reach another FD, the context of security group from the source FD is lost. Implementations of the present disclosure address these and other issues.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates a system for implementing network security between functional domains in accordance with various implementations.

FIG. 2 is a flow diagram of a process illustrating an example for a implementing network security between functional domains in accordance with various implementations.

FIG. 3A is a flow diagram of a process illustrating an example of data packet egress in accordance with various implementations.

FIG. 3B is a flow diagram of a process illustrating an example of data packet ingress in accordance with various implementations.

FIG. 4 illustrates an example of an FQSG policy data structure with a functional instance (FI) and functional domain (FD) type in accordance with various implementations

FIG. 5 illustrates an example of an FQSG policy override data structure with FD instances in accordance with various implementations.

FIG. 6 illustrates a block diagram showing an example of an implementation of the transmission of data packets with FQSG fields using an overlay tunnel in accordance with various implementations.

FIG. 7A is a block diagram illustrating an electronic device in accordance with various implementations.

FIG. 7B is a block diagram of a deployment environment in accordance with various implementations.

### DETAILED DESCRIPTION

As introduced above, security group policies affecting a data packet in a source functional domain (FD) may be lost when the data packet is sent to a second FD. In particular, in some cases the granularity of security enforcement in the destination FD is only at a source FD Internet protocol (IP) level. As a result, all the source FD services can converge into a single IP-based “allow” listing that is allowed between source and destination FDs.

As described in more detail below, implementations of the present disclosure address these and other issues by providing a new fully qualified security group (FQSG) to that can be encoded into a unique identifier in a header encapsulating a data packet, and the packet relayed between two FDs using an overlay tunnel. Once the packet reaches the destination FD, the identifier from the encapsulating header can be extracted and analyzed/decoded to get the source FQSG information and identify the appropriate FQSG source policy. Based on policy from the source FQSG, the destination FD may either allow or drop the packet.

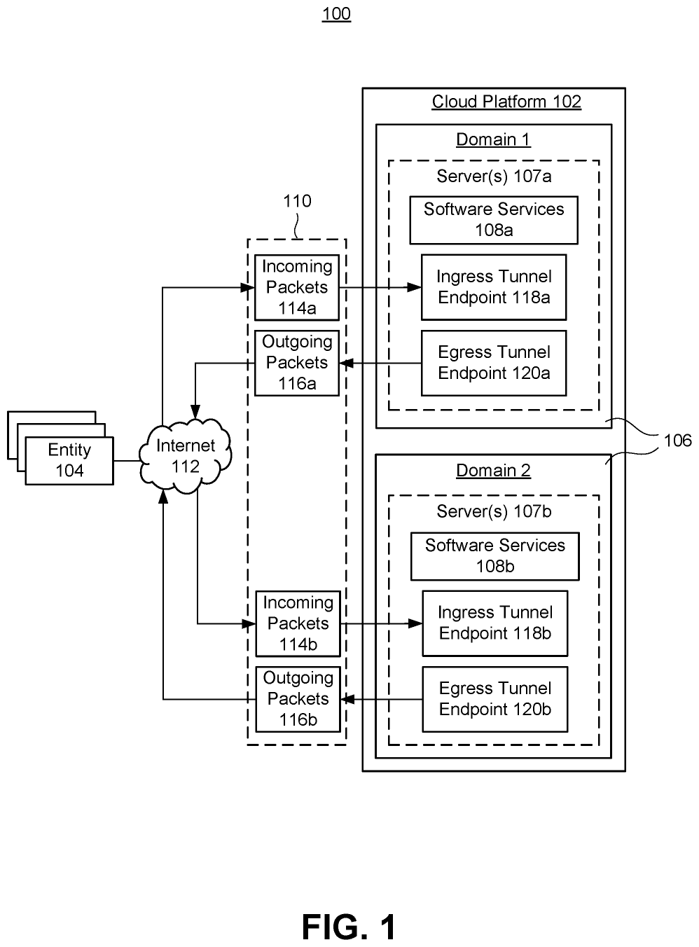

FIG. 1 illustrates an example of a system for implementing communications between two different functional domains. In this example, system 100 includes a functional instance (a cloud platform) 102, which may be implemented as an Internet-based data center comprising software and hardware (e.g., servers) that co-exist at scale. According to the disclosed implementations, the cloud platform 102 may comprise a public cloud or a hybrid cloud. A public cloud may be provided by a third-party cloud service provider that delivers computing resources over the Internet. Examples of cloud service providers include Amazon Web Services (AWS), Google Cloud Platform, Alibaba, Microsoft Azure, and IBM Bluemix. A private cloud is a private cloud platform exclusive to a single entity 104, where an entity is typically a business, research organization or enterprise, but may also be an individual. A hybrid cloud is a combination of public and private cloud platforms, where the private cloud is usually in an on-site data center or hosted by a third-party service provider. Data and applications may move seamlessly between the public and private cloud platforms. A hybrid cloud gives the entity greater flexibility and helps optimize infrastructure, security, and compliance.

One or more entities 104 may access the functional instance/cloud platform 102 to access compute services such as servers, databases, storage, analytics, networking, software and intelligence from the cloud platform 102. The cloud platform 102 may provide scalable computing capacity in the form of virtual private clouds (VPCs) in which entities 104 can launch as many or as few servers 107 as they need, configure security and networking, and manage storage. Virtual private clouds (VPCs), may include various configurations of CPU, memory, storage, and networking capacity for each entity's instances. An example of such an environment is Amazon Elastic Compute Cloud™ (Amazon EC2), which provides scalable computing capacity in the AWS cloud.

In some implementations, to leverage the global infrastructure provided by cloud service providers and to expand software services into other geographies, entities 104 may locate software services 108a and 108b (collectively referred to as software services 108) from in-house systems to the cloud. In this example, software services 108a of the entity 104 are uploaded to cloud Domain 1 and software services 108b of the entity 104 are uploaded to Domain 2 within the cloud platform 102. As used herein, a cloud domain is a distinct subset of the internet with IP addresses sharing a common suffix (e.g., a name of the entity “salesforce”) or under the control of a particular entity. In the example, shown, respective cloud domains 106 may include a set of one or more servers 107a and 107b that execute the software services 108 therein. Sometimes, respective domains 106 may be associated with specific business units or projects of the entity 104. While this example illustrates Domain 1 and Domain 2 as being within the same functional instance/cloud platform, in alternate implementations different domains may be implemented within different functional instances/cloud platforms.

During operation, a software service 108 hosted by a cloud domain 106 of a particular business unit of the entity 104 (e.g., Domain 1) may need to communicate with another software service hosted by another cloud domain 106 of a different business unit (e.g., Domain 2), and the two domains may have different communication policies. When the two cloud domains wish to communicate with each other, network traffic 110 (“traffic”) in the form of data packets (comprising both incoming packets 114a and 114b and outgoing packets 116a and 116b) may travel through the public Internet 112 and/or a trusted channel of the entity 104 depending on how the software services 108 are deployed. As used herein, the incoming packets 114a and 114b and outgoing packets 116a and 116b may be collectively referred to as incoming packets 114 and outgoing packets 116, respectfully.

More specifically, cloud domain (CD) communication paths can be broadly classified as: i) intra-CD communication, ii) inter-CD private link communication, and iii) CD to Public Endpoint communication. Intra-CD communication is the transfer of data packets from server to server (or service to service) within the cloud platform (or VPC). This traffic does not necessarily involve communicating with a public endpoint. All the traffic among the services within a CD 106 may be routed through tunnel endpoints and governed by policies defined through security groups.

Inter-CD private link communication pertains to when a service 108 within a CD needs to communicate with the private IP space of another infrastructure of the entity 104. Cloud native solutions may govern the access policies for this case.

CD to Public Endpoint communication pertains to the traffic between a service 108 within a CD and an external endpoint in the public IP space. The external endpoint can be controlled by a party other than the entity 104 on the internet (e.g., 3rd party integrations) as well as public endpoint of the entity 104 (e.g., gus/org62, public endpoint of another CD). A public proxy may be responsible for enforcing access controls for this communication path.

In the example shown, Domains 1 and 2 are provided with ingress tunnel endpoints 118a and 118b (collectively referred to as ingress tunnel endpoints 118), and egress tunnel endpoints 120a and 120b (collectively referred to as egress tunnel endpoints 120) to handle incoming data packets 114 and outgoing data packets 116, respectively.

As illustrated, each domain 106 and/or private network, has several exemplary components including a plurality of servers 107 (and storage devices), software services 108, ingress and egress tunnel endpoints 118 and 120, and any technology on which other technologies are built in multi-cloud and hybrid cloud environments. It will be appreciated there may be fewer or more components, and in particular illustrated items may represent a high level abstraction of multiple underlying hardware and/or software features or functionality to be accessed to perform operations as described herein.

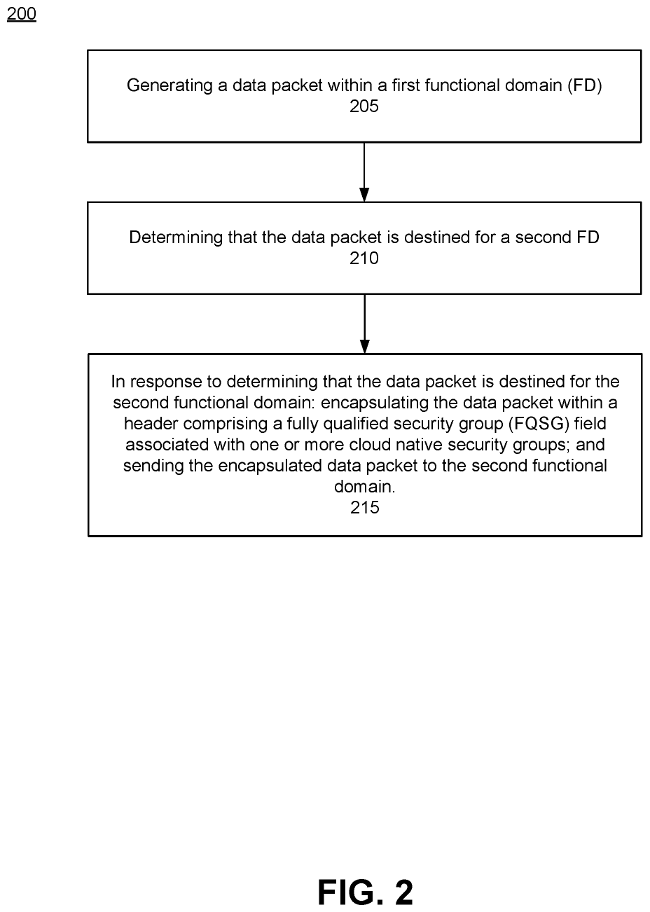

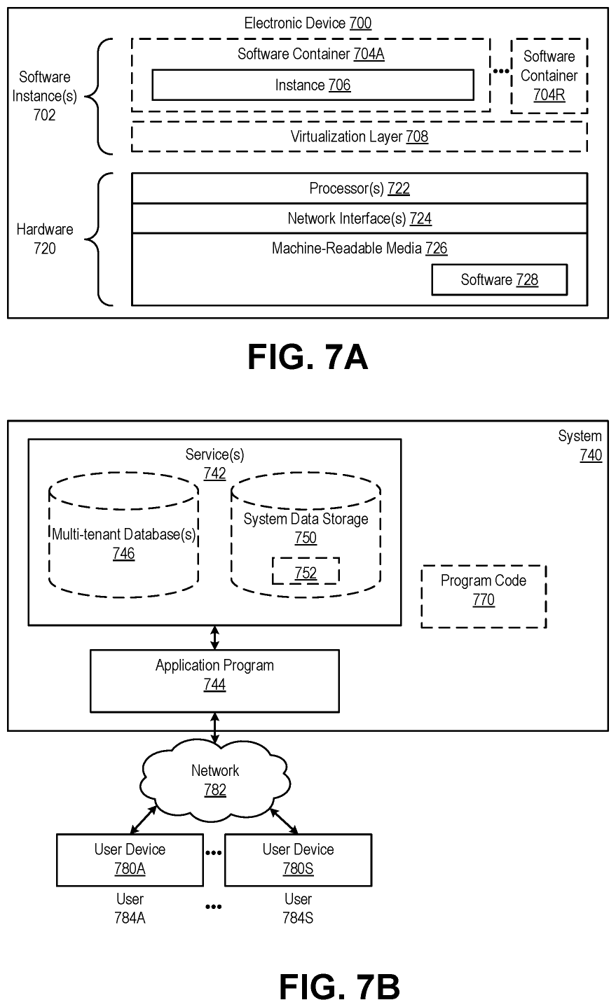

FIG. 2 illustrates a flow diagram for an example of a process in accordance with various implementations. Implementations of the present disclosure may implement more or fewer steps than illustrated in FIG. 2. Implementations of the present disclosure may implement the process shown in FIG. 2 (and other processes described herein) using any suitable combinations of systems and devices, including the systems illustrated in FIGS. 1, 7A, and 7B.

In the example depicted in FIG. 2, process 200 includes, at 205, generating a data packet within a first functional domain (FD), such as Domain 1 illustrated in FIG. 1. The process further includes, at 210, determining that the data packet is destined for a second FD, such as Domain 2 in FIG. 1. Process 200 further includes, at 215, in response to determining that the data packet is destined for the second functional domain: encapsulating the data packet within a header comprising a fully qualified security group (FQSG) field associated with one or more cloud native security groups; and sending the encapsulated data packet to the second functional domain.

In some implementations, the first functional domain and second functional domain may be within a common functional instance, as is illustrated with Domain 1 and Domain 2 in FIG. 1. In other implementations, different functional domains may be within different functional instances.

In some implementations, the one or more cloud native security groups associated with the FQSG field may be defined based on a risk profile. In some cases, security groups may be defined based on an aggregation of multiple cloud native security groups. High-level examples of such security groups (SGs) include: a processing SG, a restricted SG, a management gateway SG, a management truth SG, a perimeter services SG, an edge SG, and a perimeter load balancer SG. In some implementations, applications may be classified into such security groups and segmented at a macro level in a functional domain.

Among other things, implementations of the present disclosure can help expand the scope of conventional security groups (which may be local in scope and limited to a single FD) to span a global context across different functional domains and functional instances. For example, some implementations may utilize a fully qualified security group that is qualified by: <Instance_Name>.<Functional_Domain_Name>.<Security_Group>. One particular example of such a FQSG may thus be: aws-dev1-uswest2.foundation.processing.

Implementations of the present disclosure may operate in conjunction with a variety of different use cases. For example, one such use case for FQSG includes the ability to enforce end-to-end security policy across FI/FD boundaries. In such cases, the FQSG can be hashed into a unique numerical value. This value (e.g., a source FQSG) can then be embedded into a packet in a data path on the egress side and a security policy can be enforced on the ingress side by retrieving the source FQSG from the packet and applying the policy. Among other things, this helps to decouple policy enforcement from substrate technology and IP addresses. As a result, this paradigm can be implemented across different platforms.

Other use cases may employ implementations of the present disclosure to utilize an FQSG acting as a group identity that is embedded into a packet in a data path. One such use case includes monitoring statistics across different FQSGs to give better visibility of the traffic flow between different FI, FD, and SG entities. Another such example includes providing customized alerts on packet drops with certain SGs (e.g., “restricted” SGs) to detect potential threats. Yet another example includes building network flow and predictive analytics based on flow statistics across different FQSGs.

Implementations of the present disclosure may be realized in a variety of different ways. For example, some implementations may use a vendor/open source solution which offers tunneling or the capability to embed custom data in the packet and enforce packet admission based on the custom data. Additionally or alternatively, some implementations may utilize an in-house tunneling/overlay solution with control and data plane using industry-proven technologies.

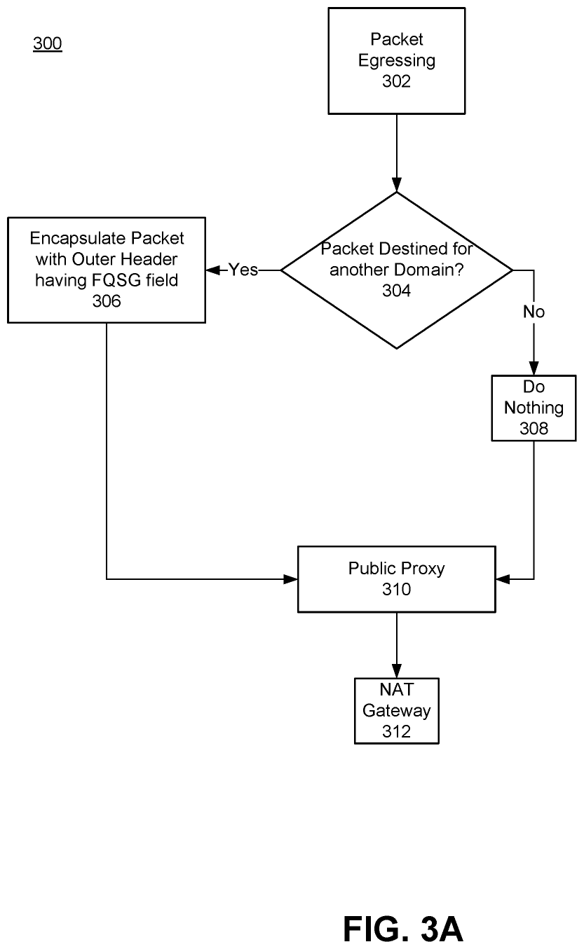

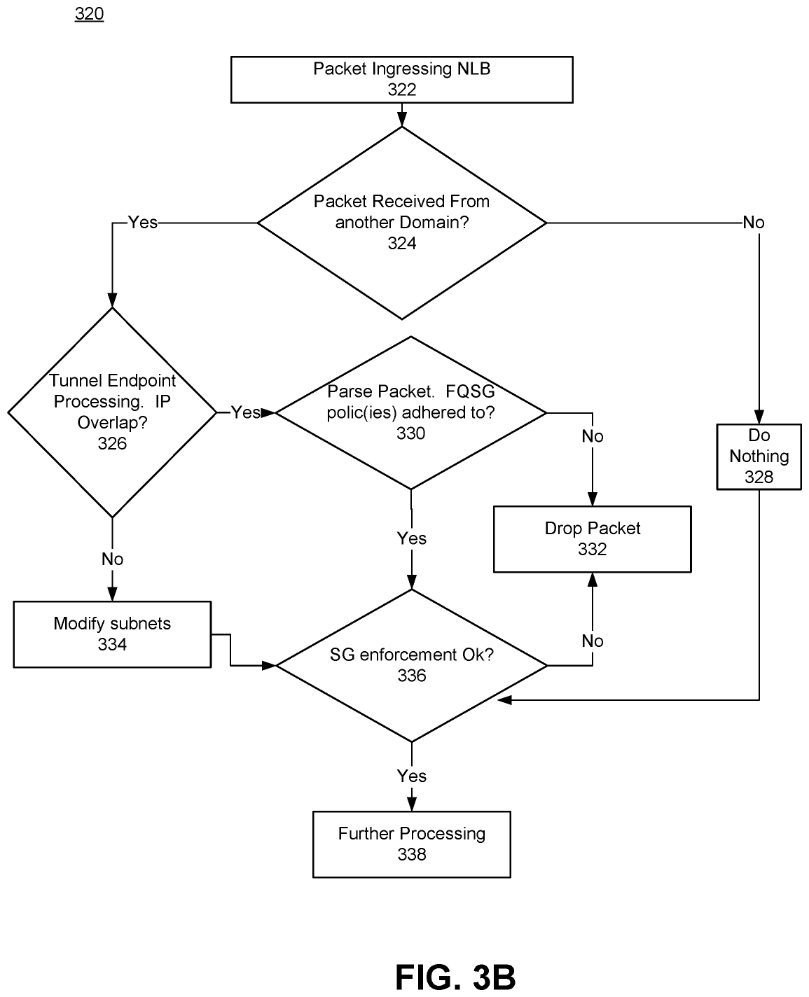

FIG. 3A illustrates a flow diagram showing an example of a process 300 for handling egress of a data packet in accordance with various implementations. The process may be implemented by an egress tunnel endpoint, such as the egress tunnel endpoints 120 illustrated in FIG. 1. In this example, process 300 includes identifying a packet egressing from a first functional domain at 302. At 304, the system determines whether the packet is destined for another (e.g., a second) functional domain. In response to determining that the data packet is destined for another functional domain, the system encapsulates the data packet within a header comprising a fully qualified security group (FQSG) field associated with one or more cloud native security groups at 306. In this example, if the data packet is not destined for another domain the system does not encapsulate the data packet with the header at 308. The data packet (encapsulated with the header or not) is then routed to a public proxy at 310 and NAT gateway at 312 for transmission.

FIG. 3B illustrates a flow diagram showing an example of a process 320 for handling egress of a data packet in accordance with various implementations. The process may be implemented by an ingress tunnel endpoint, such as the ingress tunnel endpoint 118 illustrated in FIG. 1. In this example, process 320 identifies, at 322 an ingressing data packet (e.g., from a network load balancer (NLB)). At 324, the system (e.g., in a destination functional domain) performs tunnel endpoint processing to determine whether the packet is from another functional domain (e.g., a source functional domain). If the packet is not from another FD, the system does nothing and 328 and skips to security group enforcement at 336 described below.

At 326, if the data packet is from another functional domain, the system determines whether there is IP overlap between the source functional domain and the destination functional domain. If there is overlap, at 330 the system parses the data packet with respect to the security policies of at least the source FQSG policy and either proceeds to 336 to check security group enforcement or drops the data packet at 332 if the FQSG policy is not adhered to. In some implementations, the data packet must adhere to the FQSG policies of both the source FD and the destination FD. If there is no overlap, the system modifies the source subnet to align with the source FQSG subnet at 334.

For example, for non-overlapping IP spaces where the subnets of the source FD and destination FD do not overlap, the enforcement of the security polic(ies) can be performed in the destination FD using the cloud native security groups. The source subnet can be used to source network address translate (SNAT) the packet once it reaches the destination FD, and the security group programming may allow or drop the data packet based on a policy which translates to subnets programmed to an “allow” list.

In another example, in the case of at least partial overlapping IP space between the subnets source and destination FDs, the source IP subnet may not necessarily be unique in the destination FD. In such cases, enforcement may be implemented in a software layer after the outer header is removed and the source FQSG is inferred from the identifier. The system may decide to allow or drop the data packet after analyzing the policy from source to destination FQSG.

Referring again to FIG. 3B, the system determines whether ingress/gateway service instance security group policies are adhered to, the data packet is subject to further processing at 338. Otherwise, the packet is dropped at 332.

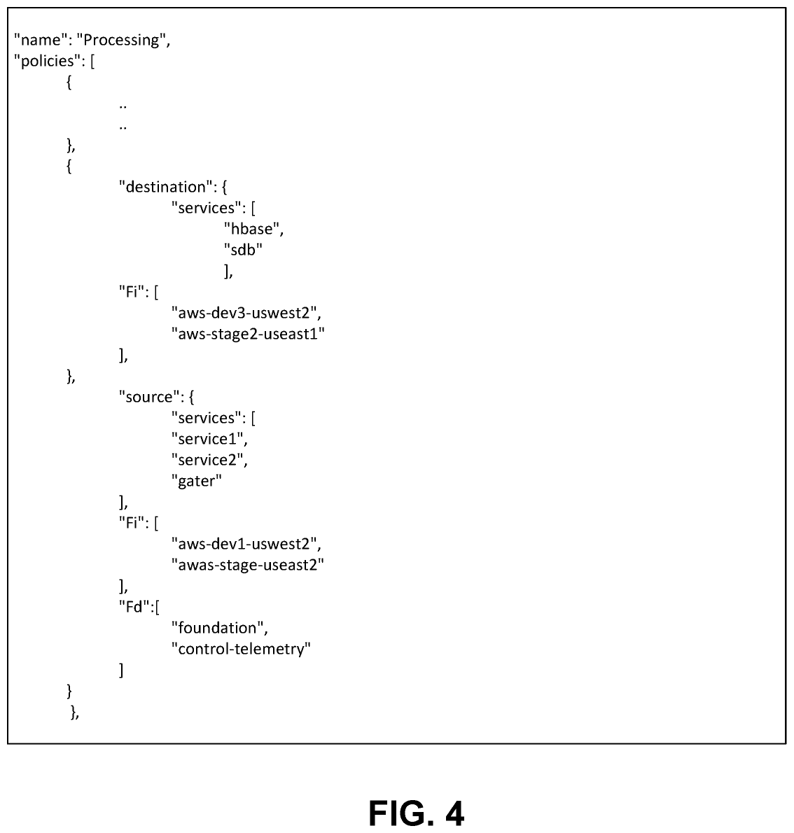

The FQSG field of the encapsulating data packet may be associated with an FQSG policy comprising a plurality of parameters. FIG. 4 illustrates an example of an FQSG policy data structure with a functional instance (FI) and functional domain (FD) type in accordance with various implementations. In this example, the destination FD may be implicit where the policy definition is defined elsewhere (e.g., in a destination FD type file).

In the example illustrated in FIG. 4, the FQSG policy may include a “destination” parameter associated with the second (destination) domain. The data structure in FIG. 4 identifies a service associated with the second functional domain and a functional instance associated with the second functional domain. Similarly, the FQSG policy data structure includes a source parameter associated with the first (source) functional domain and identifies services and a functional instance associated with the first functional domain. The FQSG policy may additionally or alternatively include any other suitable parameters associated with a security group. For example, the source parameter in FIG. 4 further identifies foundation and control telemetry features associated with the first functional domain.

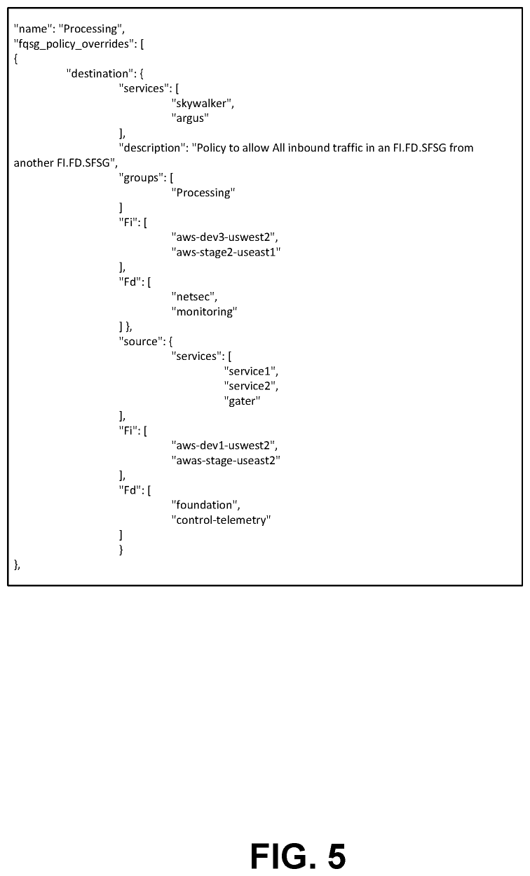

In some implementations, the FQSG field may be associated with an FQSG policy that is to override a pre-existing FQSG policy. FIG. 5 illustrates an example of an FQSG policy override data structure with FD instances in accordance with various implementations. The FQSG policy override data structure includes a plurality of parameters similar to the data structure illustrated in FIG. 4 and described above. In some implementations, the override may be defined within an FD instance to avoid defining an FD instance in the destination policies. Among other things, this allows for a more granular policy definition for an FD instance.

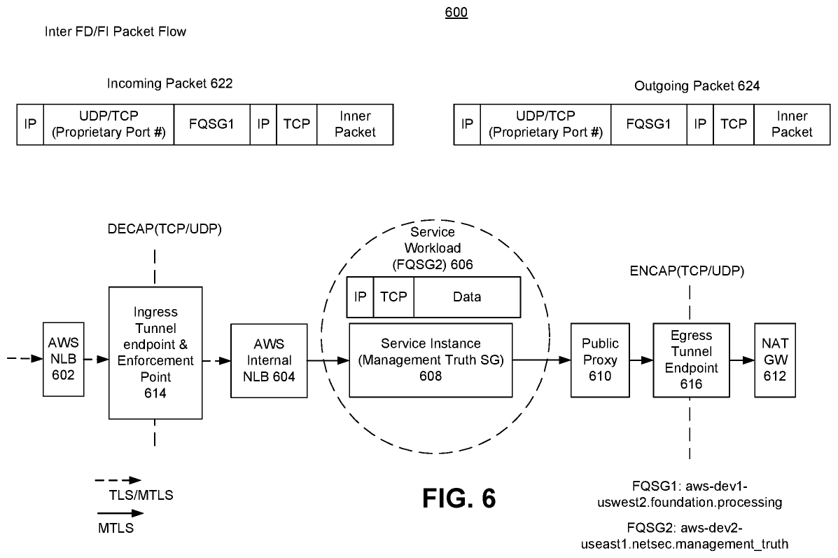

FIG. 6 illustrates a block diagram showing an example of an implementation of the transmission of data packets with FQSG fields using an overlay tunnel in accordance with various implementations. In this example, network load balancer (NLB) 602 load balances traffic incoming to the cloud platform 102 and/or to a domain 106. Similarly, the internal NLB 604 load balances traffic inside a virtual network. The service workload 606 is an infrastructure layer for facilitating network-based communications between service instances. In some implementations, the service workload 606 functions as a dedicated communication layer that routs requests from one service to another service.

The public proxy 610 is a forward proxy service in the entity's first-party data-centers that provides outbound access to all public domain names and IP addresses from the systems within the entity's data-centers. In some implementations, direct access to the Internet is forbidden for these internal systems. The public proxy 610 is a foundational service of each cloud domain 106 and resides in the cloud domains. In some implementations, the public proxy 610 has both private and public subnets, where the public proxy hosts reside in the private subnets. The public proxy service 610 has a route out to the Internet through the NAT gateway 612.

The NAT gateway 612 provides a network address translation (NAT) service so that instances in a private subnet can connect to services outside the entity's virtual private cloud (VPC) but external services cannot initiate a connection with those instances.

In operation, an incoming packet 622 with IP and TCP header information for an inner packet is encapsulated by an outer header with: IP, UD/TCP information, and an FQSG field (FQSG1 in this example). The incoming packet 622 is received at the ingress tunnel endpoint and enforcement point 614, which may perform a process (such as the process described in FIG. 3B). During such a process, the system analyzes the FQSG field from the outer header to identify an FQSG policy associated with one or more cloud native security groups from the source functional domain.

The service workload 606 processes the data packet based on the FQSG policies of the source and destination functional domains and either allows the packet to pass to the public proxy 610 or drops the packet if it does not adhere to the FQSG policies.

If allowed to the public proxy 510, the packet is eventually transmitted across the Internet to a target destination. The egress tunnel endpoint 516 may perform a process (such as the process described in FIGS. 2 and 3A) to determine if the incoming data packet 622 is intended for another functional domain and (if so) encapsulates the data packet with an outer header with a new FQSG field (FQSG2) to create outgoing packet 624, as described in FIG. 3A.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

### Electronic Devices and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.) includes hardware and software. For example, an electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

FIG. 7A is a block diagram illustrating an electronic device 700 according to some example implementations. FIG. 7A includes hardware 720 comprising a set of one or more processor(s) 722, a set of one or more network interfaces 724 (wireless and/or wired), and machine-readable media 726 having stored therein software 728 (which includes instructions executable by the set of one or more processor(s) 722). The machine-readable media 726 may include non-transitory and/or transitory machine-readable media. Each of the previously described clients and the network protocol for extending a trust boundary between cloud domains of the same entity may be implemented in one or more electronic devices 700. In one implementation: 1) each of the clients is implemented in a separate one of the electronic devices 700 (e.g., in end user devices where the software 728 represents the software to implement clients to interface directly and/or indirectly with the network protocol for extending a trust boundary between cloud domains of the same entity (e.g., software 728 represents a web browser, a native client, a portal, a command-line interface, and/or an application programming interface (API) based upon protocols such as Simple Object Access Protocol (SOAP), Representational State Transfer (REST), etc.)); 2) the network protocol for extending a trust boundary between cloud domains of the same entity is implemented in a separate set of one or more of the electronic devices 700 (e.g., a set of one or more server devices where the software 728 represents the software to implement the network protocol for extending a trust boundary between cloud domains of the same entity); and 3) in operation, the electronic devices implementing the clients and the network protocol for extending a trust boundary between cloud domains of the same entity would be communicatively coupled (e.g., by a network) and would establish between them (or through one or more other layers and/or or other services) connections for submitting configuration data to the network protocol for extending a trust boundary between cloud domains of the same entity and returning a software package to the clients. Other configurations of electronic devices may be used in other implementations (e.g., an implementation in which the client and the network protocol for extending a trust boundary between cloud domains of the same entity are implemented on a single one of electronic device 700).

During operation, an instance of the software 728 (illustrated as instance 706 and referred to as a software instance; and in the more specific case of an application, as an application instance) is executed. In electronic devices that use compute virtualization, the set of one or more processor(s) 722 typically execute software to instantiate a virtualization layer 708 and one or more software container(s) 704A-704R (e.g., with operating system-level virtualization, the virtualization layer 708 may represent a container engine (such as Docker Engine by Docker, Inc. or rkt in Container Linux by Red Hat, Inc.) running on top of (or integrated into) an operating system, and it allows for the creation of multiple software containers 704A-704R (representing separate user space instances and also called virtualization engines, virtual private servers, or jails) that may each be used to execute a set of one or more applications; with full virtualization, the virtualization layer 708 represents a hypervisor (sometimes referred to as a virtual machine monitor (VMM)) or a hypervisor executing on top of a host operating system, and the software containers 704A-704R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 728 is executed within the software container 704A on the virtualization layer 708. In electronic devices where compute virtualization is not used, the instance 706 on top of a host operating system is executed on the “bare metal” electronic device 700. The instantiation of the instance 706, as well as the virtualization layer 708 and software containers 704A-704R if implemented, are collectively referred to as software instance(s) 702.

Alternative implementations of an electronic device may have numerous variations from that described above. For example, customized hardware and/or accelerators might also be used in an electronic device.

### Environment Example

FIG. 7B is a block diagram of a deployment environment according to some example implementations. A system 740 includes hardware (e.g., a set of one or more server devices) and software to provide service(s) 742, including services associated with the implementations described herein. In some implementations the system 740 is in one or more datacenter(s). These datacenter(s) may be: 1) first party datacenter(s), which are datacenter(s) owned and/or operated by the same entity that provides and/or operates some or all of the software that provides the service(s) 742; and/or 2) third-party datacenter(s), which are datacenter(s) owned and/or operated by one or more different entities than the entity that provides the service(s) 742 (e.g., the different entities may host some or all of the software provided and/or operated by the entity that provides the service(s) 742). For example, third-party datacenters may be owned and/or operated by entities providing public cloud services (e.g., Amazon.com, Inc. (Amazon Web Services), Google LLC (Google Cloud Platform (GCP)), Microsoft Corporation (Azure)).

The system 740 is coupled to user devices 780A-780S over a network 782. The service(s) 742 may be on-demand services that are made available to one or more of the users 784A-784S working for one or more entities other than the entity which owns and/or operates the on-demand services (those users sometimes referred to as outside users) so that those entities need not be concerned with building and/or maintaining a system, but instead may make use of the service(s) 742 when needed (e.g., when needed by the users 784A-784S). The service(s) 742 may communicate with each other and/or with one or more of the user devices 780A-780S via one or more APIs (e.g., a REST API). In some implementations, the user devices 780A-780S are operated by users 784A-784S, and each may be operated as a client device and/or a server device. In some implementations, one or more of the user devices 780A-780S are separate ones of the electronic device 700 or include one or more features of the electronic device 700.

In some implementations, the system 740 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 740 is a multi-tenant cloud computing architecture supporting multiple services, such as one or more of the following types of services: Self-Healing Build Pipeline service 742; Customer relationship management (CRM); Configure, price, quote (CPQ); Business process modeling (BPM); Customer support; Marketing; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Analytics; Community; Internet-of-Things (IoT); Industry-specific; Artificial intelligence (AI); Application marketplace (“app store”); Data modeling; Security; and Identity and access management (IAM). For example, system 740 may include an application platform 744 that enables PAAS for creating, managing, and executing one or more applications developed by the provider of the application platform 744, users accessing the system 740 via one or more of user devices 780A-780S, or third-party application developers accessing the system 740 via one or more of user devices 780A-780S.

In some implementations, one or more of the service(s) 742 may use one or more multi-tenant databases 746, as well as system data storage 750 for system data 752 accessible to system 740. In certain implementations, the system 740 includes a set of one or more servers that are running on server electronic devices and that are configured to handle requests for any authorized user associated with any tenant (there is no server affinity for a user and/or tenant to a specific server). The user devices 780A-780S communicate with the server(s) of system 740 to request and update tenant-level data and system-level data hosted by system 740, and in response the system 740 (e.g., one or more servers in system 740) automatically may generate one or more Structured Query Language (SQL) statements (e.g., one or more SQL queries) that are designed to access the desired information from the multi-tenant database(s) 746 and/or system data storage 750.

In some implementations, the service(s) 742 are implemented using virtual applications dynamically created at run time responsive to queries from the user devices 780A-780S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 760 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. Further, in one implementation, the application platform 744 includes an application setup mechanism that supports application developers' creation and management of applications, which may be saved as metadata by save routines. Invocations to such applications, including the network protocol for extending a trust boundary between cloud domains of the same entity, may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 782 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 740 and the user devices 780A-780S.

Each user device 780A-780S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 740. For example, the user interface device can be used to access data and applications hosted by system 740, and to perform searches on stored data, and otherwise allow one or more of users 784A-784S to interact with various GUI pages that may be presented to the one or more of users 784A-784S. User devices 780A-780S might communicate with system 740 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 780A-780S might include an HTTP client, commonly referred to as a “browser,” for sending and receiving HTTP messages to and from server(s) of system 740, thus allowing users 784A-784S of the user devices 780A-780S to access, process and view information, pages and applications available to it from system 740 over network 782.

### Conclusion

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims. The description is thus illustrative instead of limiting.

What is claimed is:

1. A computer system comprising:
a processor; and
memory coupled to the processor and storing instructions that, when executed by the processor, are configurable to cause the computer system to:
generate a data packet within a first functional domain;
determine that the data packet is destined for a second functional domain; and
in response to determining that the data packet is destined for the second functional domain:
encapsulate the data packet within a header comprising a fully qualified security group (FQSG) field associated with one or more cloud native security groups; and
send the encapsulated data packet to the second functional domain.

2. The computer system of claim 1, wherein the first functional domain and the second functional domain are within a common functional instance.

3. The computer system of claim 1, wherein the FQSG field comprises a unique identifier.

4. The computer system of claim 1, wherein the encapsulated data packet is sent to the second functional domain via an overlay tunnel.

5. The computer system of claim 4, wherein the overlay tunnel comprises user datagram protocol (UDP) or transmission control protocol (TCP).

6. The computer system of claim 1, wherein the one or more cloud native security groups is defined based on a risk profile.

7. The computer system of claim 1, wherein the first functional domain is a source domain having a first Internet protocol (IP) subnet, and wherein the second functional domain is a destination domain having a second IP subnet.

8. The computer system of claim 7, wherein the first IP subnet and second IP subnet do not overlap.

9. The computer system of claim 7, wherein the first IP subnet and the second IP subnet at least partially overlap.

10. The computer system of claim 1, wherein the FQSG field is associated with an FQSG policy comprising a plurality of parameters.

11. The computer system of claim 10, wherein a parameter from the plurality of parameters in the FQSG policy is a destination parameter associated with the second functional domain.

12. The computer system of claim 11, wherein the destination parameter identifies a service associated with the second functional domain.

13. The computer system of claim 11, wherein the destination parameter identifies a functional instance associated with the second functional domain.

14. The computer system of claim 10, wherein a parameter from the plurality of parameters in the FQSG policy is a source parameter associated with the first functional domain.

15. The computer system of claim 14, wherein the source parameter identifies a service associated with the first functional domain.

16. The computer system of claim 14, wherein the source parameter identifies a functional instance associated with the first functional domain.

17. The computer system of claim 14, wherein the source parameter identifies foundation and control telemetry features associated with the first functional domain.

18. The computer system of claim 10, wherein the the FQSG field is associated with a second FQSG policy comprising a plurality of parameters, and wherein the second FQSG policy is to override a pre-existing first FQSG policy.

19. A tangible, non-transitory computer-readable medium storing instructions that, when executed by a computer system, are configurable to cause the computer system to:
generate a data packet within a first functional domain;
determine that the data packet is destined for a second functional domain; and
in response to determining that the data packet is destined for the second functional domain:
encapsulate the data packet within a header comprising a fully qualified security group (FQSG) field associated with one or more cloud native security groups; and
send the encapsulated data packet to the second functional domain.

20. A method, comprising:
generating a data packet within a first functional domain;
determining that the data packet is destined for a second functional domain; and
in response to determining that the data packet is destined for the second functional domain:
encapsulating the data packet within a header comprising a fully qualified security group (FQSG) field associated with one or more cloud native security groups; and
sending the encapsulated data packet to the second functional domain.
